(19) United States
(12) Patent Application Publication
(10) Pub. No.: US 2015/0227500 A1
(43) Pub. Date: Aug. 13, 2015

(54) ELECTRONIC BOOK IMPLEMENTATION FOR OBTAINING DIFFERENT DESCRIPTIONS OF AN OBJECT IN A SEQUENTIAL NARRATIVE DETERMINED UPON THE SEQUENTIAL POINT IN THE NARRATIVE

(71) Applicants: JULIUS Bernard KRAFT, Austin, TX (US); Joshua Dickinson Kraft, Austin, TX (US)

(72) Inventors: JULIUS Bernard KRAFT, Austin, TX (US); Joshua Dickinson Kraft, Austin, TX (US)

(21) Appl. No.: 14/176,055

(22) Filed: Feb. 8, 2014

(51) Int. Cl. G06F 17/24; G06F 17/30; G06F 3/0483

(52) U.S. Cl. CPC G06F 17/241; G06F 3/0483; G06F 17/30014

(57) ABSTRACT

In electronic book sequential narrative stories, a reader selectable sequence of descriptions for the same character or like function element with each different description appropriate to the stage of the changing character or function element development as the narrative content progresses.

### TECHNICAL FIELD

The present invention relates to electronic books, in which there a continuous sequential narrative content displayed on a computer controlled displays such as the Kindle™ or Nook™ product lines of electronic books. In such electronic books, groups of objects such as characters in novels or functions in scientific, technical like instructional texts are being sequentially developed as the sequential narrative content progresses.

### BACKGROUND OF RELATED ART

In the last decade, electronic books have been exponentially expanding as an ever growing alternative to the conventional paper books. The advantages and disadvantages of each type of book has been extensively discussed in the art. There are of course aesthetic preferences of the readers i.e. the look and feel of each type which will resist change to some extent.

However, the electronic book industry does recognize that there are still remaining technical and ease of use limitations of electronic books. For example, electronic books are best suited for narrative content i.e. the sequential narratives tell a continuous story of groups of stories. Consequently, the greatest advances in the electronic book marketplace has been in novels, biographies and historical books. However even in this narrative “story” technology, there still remain impediments for the reader which the industry needs to address and solve. It remains difficult for the reader to navigate or jump around from page to page or section to section in an electronic book as compared to manual freedom the reader has with a hand held paper book.

### SUMMARY OF THE PRESENT INVENTION

The present invention a substantial improvement in the ease of use of a reader accessing descriptions of characters at various stages in a sequential fictional narrative content. Also in newer lines of books which teach or inform on scientific and technological subject matter as stories or sequential narratives, the invention provides for ease of use in accessing descriptions of their subject matter at various stages of the narrative.

Accordingly, the invention is directed to computer controlled display presentations of an electronic book sequential narrative content in which a plurality of objects are sequentially developed in accordance with the sequential narrative content. The invention provides for enabling a reader to obtain a description of an object which is being developed at a selected point in the sequential narrative. To explain one aspect of the invention, imagine a reader with a conventional bound paper book. He has been reading the book on and off over a period of time. In resuming reading, the reader of a novel, comes across a character name which the reader does not recognize. The reader of the bound book has the freedom to leaf back through the pages and locate the information about the named character as needed.

In a conventional electronic book, flipping back through the pages, both tedious and time consuming. The present invention provides an ease of use in electronic in accessing descriptions of such characters. When a reader selects and clicks on a character's name, the reader is provided with a description of the character whereby the user goes not have to go back through the pages of content seeking the character. However, the present invention provides much more information.

In a fictional novel, depending on the complexity of the novel, there may be several characters “under development” i.e. the character develops and changes as the sequential narrative content of the novel progresses. Consequently, the description of the significant character being developed must correspond to the sequential level or stage of the novel at which the user selects the character name in the narrative. Too little information about a changing character could be insufficient to bring the reader to the point where the reader should to maximize the reader's attention and understanding of the progressing novel narrative. Too much information about the named character before the appropriate point in the sequential narrative could confuse and hinder the reader's progress through the future narrative.

As will be hereinafter described in greater detail, the present invention provides a sequence of descriptions for the same character with each different description appropriate to the stage of the character development as the narrative content progresses.

It will be understood that while the embodiment of this invention will hereinafter be described with an illustrative character in a novel, the same principles are applicable to reader selected terms representative of objects or functions being developed in sequential narrative scientific and technical texts or treatises in which several objects are being described in developmental stages in narratives which inform and teach by “telling a sequential story”. Such informing and teaching by developing objects of interest in narrative sequences have been gaining stature in that field as a more interesting and less boring alternative to conventional text books. In such a narrative for example, a object termed a “pressure valve” could be developed and expanded on as the sequential narrative in a hydrodynamics text content progresses. In such a situation, there could be several different descriptions of the object corresponding to the object's progressive development as the hydrodynamic text content.

Thus, the implementation of the present invention provides the sequential narrative of an electronic book storing, for each of a plurality of objects in the book, a set of different descriptions for each object, each description corresponding to a different sequential level of the object development in the sequential narrative content. The reader is enabled to select a text term representative of an object in the sequential narrative, and in responsive to this reader selecting the text term, the level of the sequential narrative content is determined. Then the stored object description for this determined level is displayed.

The electronic book narrative may be a story, and the selected text term would be a name of a character in the story. This character may have multiple different names represented by multiple different text terms, but in response to the selection of any of these multiple text terms, the same description of the character for said determined level would be displayed. The story may be a work of fiction.

On the other hand, the electronic book narrative may be an educational treatise presenting the sequential development of an object of knowledge, so that each different description of the object of knowledge provides only sufficient information of this object so as to enable the reader to understand the next sequential level in the development of the object in the sequential narrative. This would be applicable to scientific and technological objects.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 show illustrative diagrammatic electronic book display breakouts at six sequential stages of the narrative in an illustrative fictional novel being read with a term representing the same character along side of the corresponding stored progressive description which will be displayed upon the reader selection of the character at each respective page.

FIG. 2 is a illustrative diagrammatic view of an illustrative computer system which may used for the controlled electronic book display of this invention;

FIG. 3 is a general flowchart of a program set up to implement the present invention for enabling a reader to obtain a description of an object under development in a sequential narrative;

FIG. 4 is a flowchart of an illustrative run of the program set up in FIG. 3 as applied to a character being developed in a work of fiction; and

FIG. 5 is a flowchart of an illustrative run of the program set up in FIG. 3 as applied to a function being developed in a scientific/technological text or treatise.

### DETAILED DESCRIPTION OF THE PREFERRED EMBODIMENT

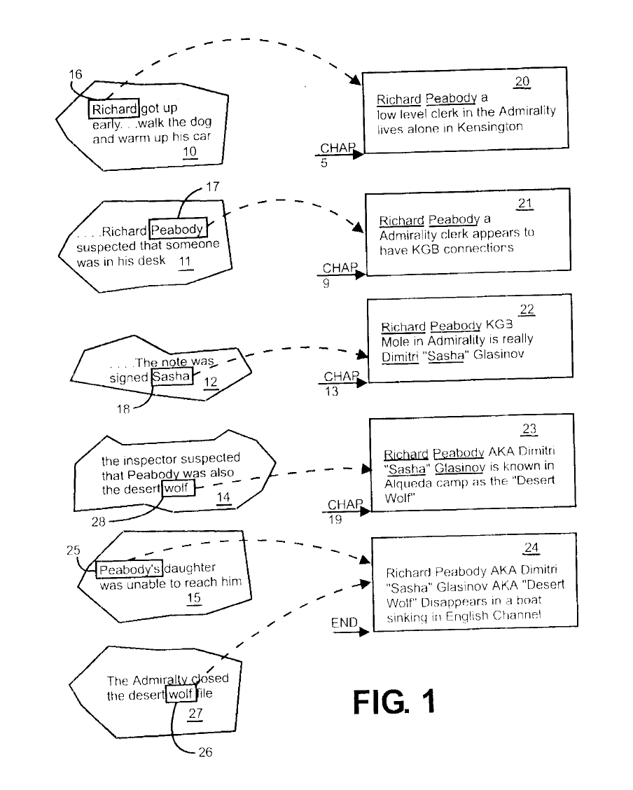

Referring to FIG. 1, there is shown a sequence of illustrative diagrammatic electronic book display breakouts at six sequential stages of the narrative in an illustrative fictional novel being read with a term representing the same character along side of a sequence of the corresponding stored progressive description which will be displayed upon the reader selection of the term for the character at each respective page.

To elaborate of these sequences, in every novel or like story, there are usually dozens of characters, many of which do not play a significant role in the progressive sequential narrative. For such characters, one description will suffice, and it would not be necessary to have multiple descriptions in accordance with the present invention. However, the present invention is directed to the characters in the novel who change and are developed as the narrative action sequentially progresses. Such developing characters can undergo significant changes in their status, identity and interrelationships as the narrative content progresses. Thus, it is very desirable, that in response to a character selection, a description which will correspond to the stage of the character development in the narrative at the point of the request will be shown.

In FIG. 1, a character Richard 16 is selected from electronic book display 10. Richard is a character who will be developed and changed as the narrative progresses. Thus, this selection results in the display for Richard Peabody of stored description 20 which provides an early stage description, before CHAPTER 5 in the narrative.

Then, when a later selection of Peabody 17 is made on display 11, this selection results in the display for Richard Peabody of stored description 21 which provides an a more developed stage description, before CHAPTER 9 in the narrative for the same Richard Peabody. It is noted that either of the character's two names, Richard and Peabody results the access of the same stored description. Further on, a selection of Sasha 18 is made on display 12, this selection results in the display for Richard Peabody of stored description 22 which provides an a more developed stage description, between CHAPTERS 9 and 13 in the narrative. It is noted from the description that Richard is a “mole” i.e he is really Dimitri “Sasha” Glasinov. Thus, in addition to other character development in Richard, there now would be five names, Richard, Peabody, Dimitri, Shasa, and Glasinov which access the same stored description 22. Then, as the narrative plot content continues the further development of the character, Richard, a selection of Wolf 28 is made on display 14, this selection results in the display for Richard Peabody of stored description 23 which provides an a more developed stage description, between CHAPTERS 13 and 19 in the narrative, wherein we now learn that Richard is a multiple agent going on the name of Desert Wolf, an Al Queda operative. With the name Wolf added, there are now six names which will access stored description 23. Accordingly, it is shown that the selection of Peabody 25 in subsequent narrative display IS or Wolf 26 in subsequent narrative display 27 will result in the access and display of the stored description 24 before the end of the narrative content which gives a description of Richard at the final stage of development.

Sequential descriptions 20-24 of the character Richard under development, are determined, set up, and stored during the initial setting up and annotating of the electronic by the book provider.

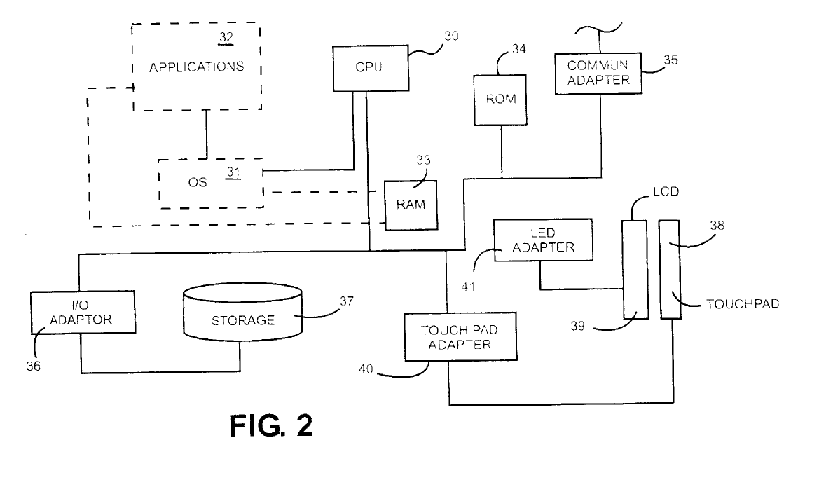

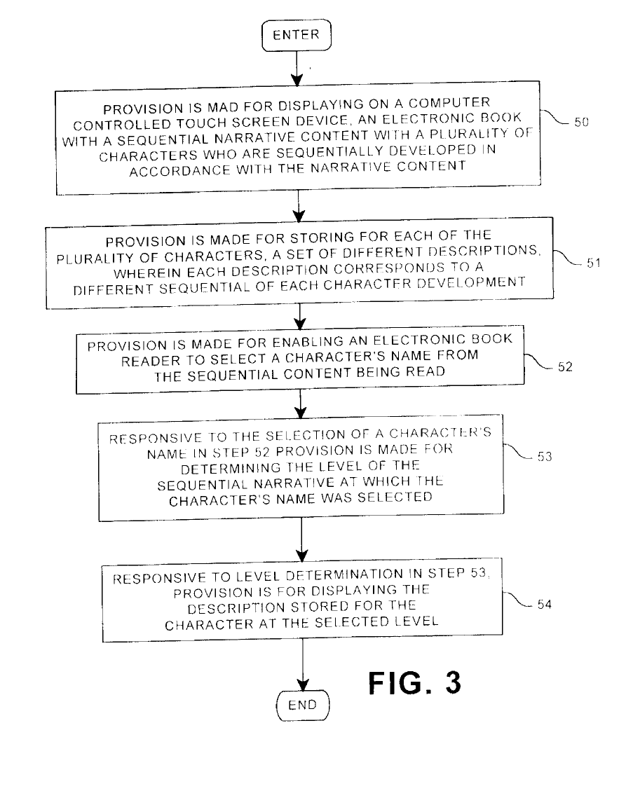

Referring now to FIG. 2, there is shown an illustrative diagrammatic view of an illustrative computer system which may used for the controlled electronic book display of this invention. The illustrative device has a computer controlled LCD display. The is a CPU 30, e.g a 1.2 GHz Deal Core, which is connected to the system components by a bus, shown as connectors. An operating system 31, e.g. a compatible Fire OS 3.0, runs on CPU 30, and coordinates the various system components including touch pad screen 58, connected through touch pad adapter 40 and LCD display screen 39 connected through LCD adapter 41. The programs of the present invention to be described hereinafter in FIGS. 3-5, which is among the applications 32 runs, in conjunction with operating system 31 to perform the accessing and display of the character descriptions of the present invention. A read only memory (ROM) 34, connected to CPU 30, includes the computer system BIOS which controls basic computer functions. Random Access Memory (RAM) 33 conveniently has from 512 MB to 1 CB capacity. I/O adapter 36 connects to storage (e.g. about 8 CB). When the system is dormant, most of the software, including operating system 41 and applications 40 are stored in disk storage device 20. I/O adapter 18 connects with storage device 20. Communication adapter 35 interconnects the computer system with outside networks and devices. The connection is typically through wireless WiFi RF communication. The system has a power supply provided by rechargeable battery.

Now with respect to FIG. 3, a general flowchart of a program set up to implement the present invention for enabling a reader to obtain a description of an object under development in a sequential narrative. Provision is made for Displaying on a computer controlled touch screen device, an electronic book with a sequential narrative content with a plurality of characters who are sequentially developed in accordance narrative, step 50. Provision is also made for storing for each of the plurality characters, a set of different descriptions with each description corresponding to a different sequential description of each character development, step 51. Provision is also made for enabling an electronic hook reader to select a character's name from the sequential content being read, step 52. Provision is then made, step 53, for determining the level of the sequential narrative at which the character's name was selected, in response to the selection of the character's name in step 52.

Finally in response to the level determination in step 53, provision is made for displaying the description stored for the character, step 54.

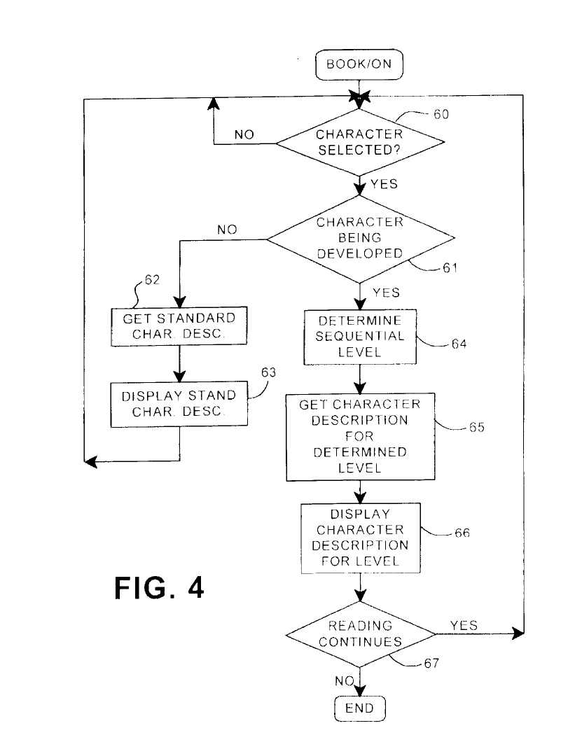

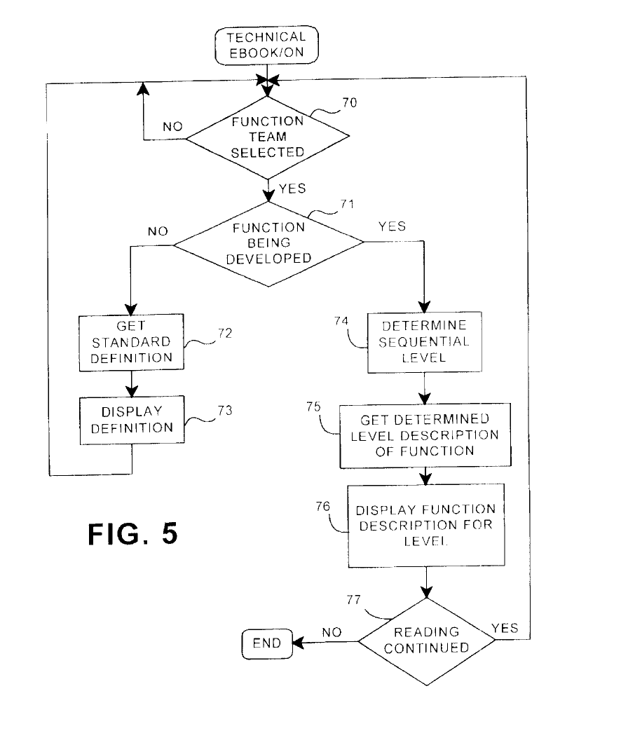

Simplified illustrative examples of runs of the process set up in FIG. 3 will be described with respect to the respective flowcharts of FIGS. 4 and 5; with FIG. 4 applied to a character being developed in a work of fiction; and

FIG. 5 applied to a function being developed in a scientific/technological text or treatise.

In FIG. 4, as the reading of the electronic book continues, a determination is continually made as to whether the name of a character has been selected by the reader for a description, step 60. If Yes, a further determination is made, step 61, as to whether the character is one who is being developed in the story i.e. sequential narrative content. If No, i.e. the character has been predetermined to be a minor character of little or no development in the narration, then then a single standard unchanging description is accessed, step 62 and displayed, step 63. This same definition of this minor character will be displayed, irrespective of where in the story narrative, the name of this minor character was selected.

On the other hand if the determination in step 63 is Yes i.e. the character is a major character, being developed in the story, then step 64, the point in the sequential narrative at which the character name was selected is determined, the description for the character at that point is accessed, step 65, and displayed, step 66. At this point, a determination may conveniently made, step 67, as to whether the reading of the book is continuing. If Yes, the processed is branched back to step 60 wherein the reading continues. If No, the electronic book reading session is ended. The programming flowchart of FIG. 5 is similar to that of FIG. 4, except that the object the description of which is being developed is a book teaching and sequentially developing object of science or technology. At the outset, it should be understood that narrative books convey or teaches elements of knowledge, there will be many functions which will be changed and built up as the book progresses. For such functions which being developed, the invention recognizes, there must be several different descriptions for the functions, with each different description being appropriate for level of development of the respective function at which the reader selects the object for description. Other the other hand, there should many functions described in the book narrative which will not be changed or developed. However, descriptions of such non-developed functions may still be needed. For such functions, a single definition will be sufficient irrespective of the point in the narrative.

Accordingly in FIG. 5, as the reading of the electronic book on technological subject matter continues, a determination is continually made as to whether the term representing a function has been selected by the reader for a description, step 70. If Yes, a further determination is made, step 71, as to whether the function is one who is being developed in the electronic text i.e. sequential narrative content. If No, i.e. the function has been predetermined to be a generally known function of little or no development in the narration, then a single standard unchanging description is accessed, step 72 and displayed, step 73. This same definition of this known function will be displayed, irrespective of where in the story narrative, the name of this known function was selected.

On the other hand if the determination in step 73 is Yes i.e. the character is a function being developed in the textbook narrative, then step 74, the point in the sequential narrative at which the function term was selected is determined, and the description for the function at that point is accessed, step 75, and displayed, step 76. At this point, a determination may conveniently made, step 77, as to whether the reading of the hook is continuing. If Yes, the processed is branched back to step 70 wherein the reading continues.

It will be understood by those skilled in the art that beyond the electronic book narrative embodiments described above in the form of fiction stories or technical works, the invention is applicable many other narrative of conveying knowledge, e.g. biography books, history treatises, hooks in economics. The electronic book should convey knowledge on particular functions and characters wherein sequential narrative descriptions of the characters or functions are needed which convey only the information which should be known about the character or function commensurate with the stage of development in the narrative.

It should be understood by those skilled in the art that aspects of the invention may be provided in the form of a system, method or program product. As set forth hereinabove, the present invention may be in the form of computer readable media having computer code stored thereon such as electrical connectors, e.g. wiring, computer diskettes, hard disks, RAMS, ROMs, EPROMs, CD-ROMs.

Although certain preferred embodiments have been shown and described, it will be understood that many changes and modifications may be made therein without departing from the scope and intent of the appended claims.

What is claimed is:

1. In a computer controlled display presentation of an electronic book sequential narrative content, wherein a plurality of objects are sequentially developed in accordance with the sequential narrative content, a method for enabling a reader to obtain a description of an object at a selected point in the sequential narrative comprising:
storing for each of said plurality of objects, a set of different descriptions for each object, each description corresponding to a different sequential level of the object development in said sequential narrative content;
enabling a reader to select a text term representative of an object in said sequential narrative;
responsive to said reader selecting said text term,
determining the level of said sequential narrative content, and
displaying the stored object description for said determined level.

2. The method of claim 1, wherein:
said electronic book narrative is a story; and
said selected text term is a name of a character in said story.

3. The method of claim 2, wherein:
said character has multiple different names represented by multiple different text terms; and
responsive to the selection of any of said multiple text terms, displaying the same description of said character for said determined level.

4. The method of claim 2, wherein said story is a work of fiction.

5. The method of claim 1, wherein said electronic book narrative is an educational treatise presenting the sequential development of an object of knowledge, and each different description of said object of knowledge provides only sufficient information for said object to enable the reader to understand the next sequential level in the development of the object in the sequential narrative.

6. The method of claim 5, wherein said object being sequentially developed is a scientific object.

7. In a computer controlled display presentation of an electronic book sequential narrative content, wherein a plurality of objects are sequentially developed in accordance with the sequential narrative content, a system for enabling a reader to obtain a description of an object at a selected point in the sequential narrative comprising:
a processor;
a computer memory holding computer program instructions which when executed by the processor perform the method comprising:
storing for each of said plurality of objects, a set of different descriptions for each object, each description corresponding to a different sequential level of the object development in said sequential narrative content;
enabling a reader to select a text term representative of an object in said sequential narrative;
responsive to said reader selecting said text term,
determining the level of said sequential narrative content, and
displaying the stored object description for said determined level.

8. The system of claim 7, wherein:
said electronic book narrative is a story; and
said selected text term is a name of a character in said story.

9. The system of claim 8, wherein:
said character has multiple different names represented by multiple different text terms; and
responsive to the selection of any of said multiple text terms, the performed method includes displaying the same description of said character for said determined level.

10. The system of claim 7, wherein said story is a work of fiction.

11. The system of claim 7, wherein said electronic book narrative is an educational treatise presenting the sequential development of an object of knowledge, and each different description of said object of knowledge provides only sufficient information for said object to enable the reader to understand the next sequential level in the development of the object in the sequential narrative.

12. The system of claim 11, wherein said object being sequentially developed is a scientific object.

13. A non-transitory computer usable storage medium having stored thereon a computer readable program for enabling a reader to obtain a description of an object at a selected point in a computer controlled display presentation of an electronic book sequential narrative content, wherein a plurality of objects are sequentially developed in accordance with the sequential narrative content, wherein the computer readable program when executed on a computer causes the computer to:
store for each of said plurality of objects, a set of different descriptions for each object, each description corresponding to a different sequential level of the object development in said sequential narrative content;
enable a reader to select a text term representative of an object in said sequential narrative;
responsive to said reader selecting said text term,
determine the level of said sequential narrative content, and
display the stored object description for said determined level.

14. The computer usable storage medium of claim 13, wherein:
said electronic book narrative is a story; and
said selected text term is a name of a character in said story.

15. The computer usable storage medium of claim 14, wherein:
said character has multiple different names represented by multiple different text terms; and
responsive to the selection of any of said multiple text terms, the computer program causes the display of the same description of said character for said determined level.

16. The computer usable storage medium of claim 13, wherein said story is a work of fiction.

17. The computer usable storage medium of claim 13, wherein said electronic book narrative is an educational treatise presenting the sequential development of an object of knowledge, and each different description of said object of knowledge provides only sufficient information for said object to enable the reader to understand the next sequential level in the development of the object in the sequential narrative.

18. The computer usable storage method of claim 17, wherein said object being sequentially developed is a scientific object.
